(19) United States
(12) Patent Application Publication
(10) Pub. No.: US 2024/0352736 A1
(43) Pub. Date: Oct. 24, 2024

(54) Multilayer Roofing Membrane and Method of Applying Same

(71) Applicant: Capital Coating, Inc., Kinzers, PA (US)

(72) Inventor: Mervin L. Fisher, Strasburg, PA (US)

(21) Appl. No.: 18/638,842

(22) Filed: Apr. 18, 2024

Related U.S. Application Data
(60) Provisional application No. 63/497,633, filed on Apr. 21, 2023.

(51) Int. Cl. E04D 7/00; B05D 7/00

(52) U.S. Cl. CPC E04D 7/005; B05D 7/587; B05D 2503/00; B05D 2518/10

(57) ABSTRACT

A roofing membrane has at least five layers, including: a first adhesion layer, a second reinforcing layer over the first layer, a third waterproofing layer over the second layer, a fourth waterproofing protection layer over the third layer, and, a fifth layer over the fourth layer comprising a weathering coating and a sacrificial coating. A method of applying the layers is also disclosed.

### CROSS REFERENCE TO RELATED APPLICATIONS

This application claims the benefit of, and claims priority to, commonly assigned U.S. Provisional Patent Application No. 63/497,633 filed Apr. 21, 2023 entitled “Multilayer Roofing Membranes and Method of Applying Same”, the disclosure of which is incorporated herein by reference in its entirety.

### TECHNICAL BACKGROUND

The subject matter of this application relates generally to roofing systems and particularly to a roofing membrane that can be applied over an existing roofing system, or directly over the sheathing or substrate material of a roofing system.

### BACKGROUND

Roofing system types are varied. Sec, e.g., https://capitalcoating.com/blog/8-types-of-commercial-roofing-systems/. Each of these types of roofing systems has its relative advantages and disadvantages, and each requires regular maintenance, and eventually replacement. Depending upon the condition of the existing roofing system, a membrane system can be applied over it instead of removing and replacing the existing roof system. However, the durability, effectiveness and longevity of known membrane systems when applied over an existing roofing system can be unreliable. In addition, preparation of the existing roofing system (or removal thereof) and installation of known membrane systems over the existing roofing system can be laborious. Furthermore, known membrane systems suitable for installation over an existing roofing system may not be suitable for use as an original installation material, and they may not be suitable for application over the original or underlying roof sheathing, metal roof substrate, etc.

### SUMMARY

There is disclosed a multilayer roofing membrane and a method for applying the same over a roofing system substrate, such as the original roof sheathing, metal substrate, etc. or over the existing roof system material, provided that the existing roofing system material is in satisfactory condition.

The disclosed roofing membrane comprises five layers: a first adhesion layer defined by a first wet application of urethane; a second reinforcing layer defined by a fabric or sheet material applied over the first layer while the first layer is wet; a third waterproofing layer defined by a second wet application of urethane over the second layer; a fourth waterproofing and protection layer defined by a wet application of silicone over the third layer after the third layer has dried; and, a fifth weathering and sacrificial layer defined by a second wet application of silicone over the fourth layer and an application of grit/granules over the second wet application of silicone while still wet.

The disclosed method for applying the membrane system comprises: removing the existing roofing material, if needed, and thoroughly cleaning the roof surface (existing roof material, original sheathing, original substrate, etc.); applying an adhesive urethane layer over the roof surface; applying a reinforcement fabric or sheet layer over the adhesive layer; applying a waterproof urethane layer over the reinforcement layer; applying a waterproofing silicone protection layer over the waterproof layer; and, applying a weathering and sacrificial layer over the weatherproofing protection layer

It has been found that the claimed roofing membranes, and roofing membranes applied according to the claimed methods, provide superior results over known membrane systems.

### BRIEF DESCRIPTION OF THE DRAWINGS

FIG. 1 illustrates a multiple layer roofing membrane according to one aspect of this disclosure.

FIG. 2 is a cross section of a roofing membrane taken through line 2-2 of FIG. 1.

FIG. 3 illustrates a method of applying a roofing membrane.

### DETAILED DESCRIPTION OF THE DISCLOSED EMBODIMENT

In general, the claimed and disclosed membrane is created by applying multiple layers in liquid form and/or sheet or fabric form as described herein. The resulting membrane is superior to known roofing materials in terms of durability, waterproofing, weatherproofing and case of application.

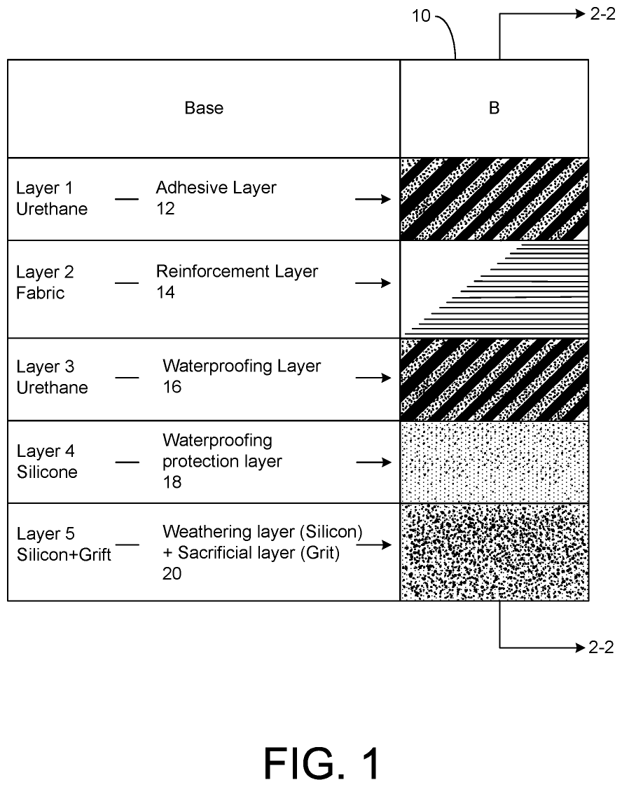

Referring to the Figures, wherein like numerals represent like elements, there is shown in FIG. 1 a roofing membrane system 10 according to the present disclosure. Membrane 10 comprises multiple layers 12-20, applied sequentially, as described herein.

First layer 12 is applied over a base B which may be the existing roofing system material (if the existing roofing system has not been removed) or the sheathing or substrate of the roof (either the exposed sheathing/substrate after the existing roofing system material has been removed, or the new sheathing or substrate if the roof is new or if all or some of the sheathing or substrate has bene replaced).

First layer 12 is a preferably a urethane coating that defines an adhesion layer applied in fluid/liquid form by a roller, brush, spray, squeegee, or other acceptable method of fluid application. Layer 12 is applied directly over the existing roofing system material (if in satisfactory condition) or over the original roof sheathing or metal roof substrate (e.g., if the original roofing system material has been removed or if the membrane is being applied over a new sheathing or substrate. Layer 12 is preferably applied such that, when dry, it has a nominal thickness of about 6 mils.

Second layer 14 is preferably a polyester fabric or sheet material, such as fiberglass or suitable textile material, applied over the first layer 12 while layer 12 is still wet (i.e., while layer 12 is in liquid or fluid form). The second layer 14 may be of any suitable thickness such that it serves as a reinforcing layer between the first layer 12 and a third layer 16, and such that, as described below, the combined thickness of second layer 12 and third layer 16 is about 11 mils.

Third layer 16 is also preferably a urethane coating and defines a waterproofing layer, applied over the second layer 14 in the same manner as the first layer 12. Third layer 16 is preferably applied such that, when dry, the combined thickness of second layer 14 and third layer 16 is about 11 mils. Advantageously, layers 12, 14 and 16 may be applied in rapid succession without regard to drying time of the first layer 12.

Fourth layer 18 is a silicone layer that is applied over third layer 16 after layer 16 has been permitted to dry. Layer 18 defines both a waterproofing layer and a protection layer. Preferably, the thickness of the fourth layer is about 11 mils when applied. Fourth layer 18 may be applied in the same manner as the first and third layers 12, 16.

Fifth layer 20 comprises a combination of another silicone layer and a grit/granule coating applied over the fourth layer 18. The fifth layer 20 defines a weathering and sacrificial layer. The silicone portion of fifth layer 20 may be applied in the same manner as in the fourth layer, such that, excluding the grit/granule layer, the silicone portion of the fifth layer has a thickness of about 11 mils. Grit/granules are preferably applied while the silicone portion of fifth layer 20 is wet, at a weight/area ratio of about 0.31b/ft². The grit/granules may comprise a granulized material such as crushed glass, quartz, silica, stone, rubber, cork and the like.

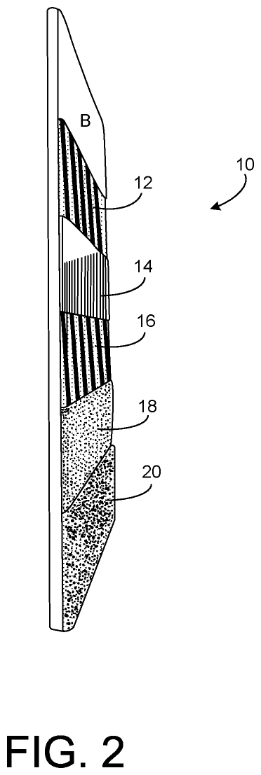

FIG. 2 is a cross section taken through line 2-2 of FIG. 1 and illustrates the relative change in thickness of the combined layers of the membrane from first layer 12 to fifth layer 20.

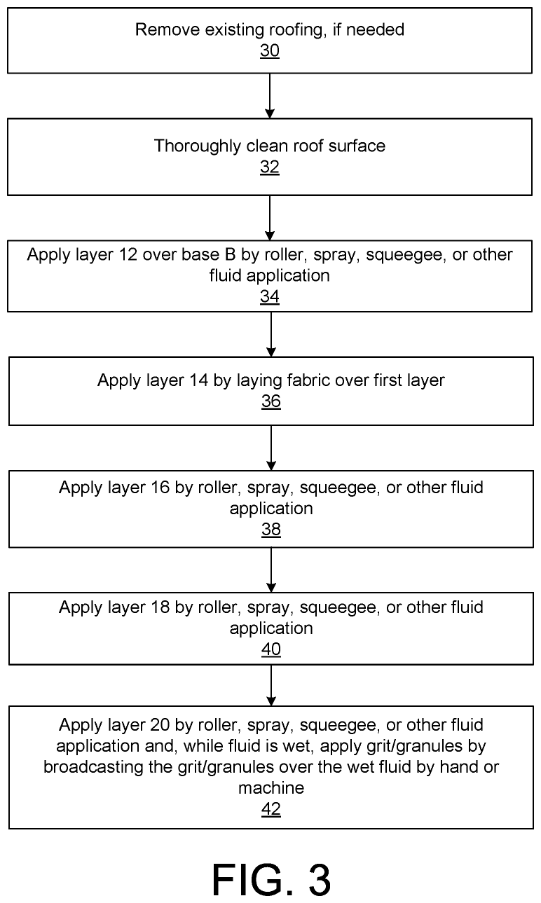

FIG. 3, steps 30-42, illustrate the application method described above.

The layers 12-20 are preferably applied at temperatures between 0 degrees F. and rising and 5 degrees F. above dew point. Once all layers have been applied and permitted to dry, they define a composite membrane.

The first and third layers 12, 16 may each be EVER-THANE® BASE PLUS Single Component, Fire Retardant, Aromatic Urethane Cool Roof Base Coat. https://www.everroof.com/docs/TDS/URETHANES/Ever-Thane%20Base%20Plus.pdf#:˜:text=Ever-Thane%20Base%20Plus%20is%20a%20versatile%2C%20multi%20purpose%2C,metal%2C%20built-up%20roofs%2C%20modified%20bitumen%2C%20and%20concrete%20roofs.

The second layer 14 may be Tietex T272 Roofing Fabric. https://www.neogard.com/Portals/0/NeogardDocBuilder/Uploaded%20Docs/8622 0-PDS.pdf

The fourth layer, and the silicone employed in the fifth layer 20, may be EVER-SILIC® HS Single Component High Solids Silicone Cool Roof Top/Base Coat. https://www.everroof.com/docs/TDS_2019/SILICONES/ER-TDS-EVER-SILIC-HS-190820AA.pdf

The grit/granules employed in the fifth layer may be SGI roofing Granules. https://specialtygranules.com/products/roofing.

In addition to being capable of being applied directly over an existing roof sheathing or substrate, the disclosed roofing membrane system may be applied over existing single layer/single ply roofing systems, multi-layer/built up roofing systems, asphalt roof shingle systems, and foam board roofing systems, among others. The disclosed membrane system may be applied over both flat and pitched roofs.

The benefits of the disclosed roofing membrane system are many. It can be applied over an existing roofing system and thus does not require removal thereof. It is seamless and does not require the use of any mechanical fasteners, nor does it require any penetration of the existing roofing system or the roofing substrate or sheathing. It is highly durable and has a much longer useful life than existing membrane systems, and thus allows the installer to offer much longer warranties.

1. A roofing membrane comprising at least five layers comprising:
a) a first adhesion layer;
b) a second reinforcing layer over the first layer;
c) a third waterproofing layer over the second layer;
d) a fourth waterproofing protection layer over the third layer; and,
e) a fifth layer over the fourth layer comprising a weathering coating and a sacrificial coating.

2. The roofing membrane according to claim 1 wherein the first layer comprises a urethane coating.

3. The roofing system according to claim 1 wherein the second layer comprises a polyester fabric or a textile sheet material.

4. The roofing system according to claim 1 wherein the third layer comprises a urethane coating.

5. The roofing system according to claim 1 wherein the fourth layer comprises a silicone coating.

6. The roofing system according to claim 1 wherein the fifth layer comprises a silicone and a frit/granule coating.

7. A roofing membrane comprising:
a) a first urethane coating defining an adhesion layer;
b) a polyester fabric or a textile sheet material over the adhesion layer defining a reinforcing layer;
c) a second urethane coating over the reinforcing layer defining a waterproofing layer;
d) a silicone coating over the waterproofing layer defining a waterproofing protection layer; and,
e) a combination of a second silicone coating defining a weathering layer and grit/granules coating thereover defining a sacrificial coating.

8. A roofing membrane comprising at least five layers comprising:
a) a first adhesion layer defined by a first wet application of urethane;
b) a second reinforcing layer defined by a polyester fabric or a textile sheet material applied over the first layer while the first layer is wet;
c) a third waterproofing layer defined by a second wet application of urethane over the second layer;
d) a fourth waterproofing and protection layer defined by a first wet application of silicone over the third layer after the third layer has dried; and,
e) a fifth weathering and sacrificial layer defined by a second wet application of silicone over the fourth layer and an application of grit/granules over the second wet application of silicone while still wet.

9. A method of applying a new roofing system over an existing roofing system comprising:
a) applying a first coating of urethane in wet form over the existing roofing system;
b) applying a polyester fabric or a textile sheet material over the first coating of urethane while the first coating of urethane is wet;
c) applying a second coating of urethane over the polyester fabric or textile sheet material in wet form;
d) applying a first coating of silicone over the second coating of urethane after the second coating of urethane has dried;
e) applying a second coating of silicone in wet form over the first coating of silicone, and while the second coating of silicone is wet, applying grit/granules over the second coating.

10. The method of claim 9 wherein the existing roofing system is a previously installed roofing system and the method comprises carrying out steps a)-e) without removing the previously installed roofing system.
